(19) United States
(12) Patent Application Publication
(10) Pub. No.: US 2018/0019539 A1
(43) Pub. Date: Jan. 18, 2018

(54) Photovoltaic Electrical Connector

(71) Applicant: CHANGSHU FRIENDS CONNECTOR TECHNOLOGY. CO., LTD, Jiangsu (CN)

(72) Inventor: Jianming Xu, Suzhou City (CN)

(21) Appl. No.: 15/118,451

(22) PCT Filed: Mar. 31, 2015
(86) PCT No.: PCT/CN2015/075484

§ 371 Date: Aug. 11, 2016

(30) Foreign Application Priority Data
Mar. 26, 2015 (CN) 201510134365.8

(51) Int. Cl. H01R 13/625; H01R 13/10; H01R 13/05

(52) U.S. Cl. CPC H01R 13/625; H01R 13/052; H01R 13/10

(57) ABSTRACT

A photovoltaic electrical connector comprising a first and a second connecting body. The first and second connecting body comprising a first and a second connecting seat, a first and a second cable and a first and a second insulating seat. One end of the first insulating seat is made to form a cylindrical plug head and one end of the second insulating seat is made to form a cylinder plug socket. The outer wall the cylindrical plug head is made to form a first annular groove. Elastic pieces are provided in the first annular groove. The outer wall of cylindrical plug socket is made to form a second annular groove and the bottom surface end is made to form slots. The side wall of the second annular groove is provided with an annular locking sleeve and the inner wall of the locking sleeve is made to form L-shape locking bolts.

### BACKGROUND OF INVENTION

### 1. Field of the Invention

The present invention is related to the technic field of solar energy photovoltaic components, more specifically, a photovoltaic electrical connector.

### 2. Description of Related Art

With the advancement in today's social and technology development clean and reusable energy are gaining increasing attention. Photovoltaic energy is an important clean and reusable energy that can be harvest unlimited. The solar panel device is often used in photovoltaic. During the photovoltaic process the connectors used with the solar panel device are especially important. Which the solar panel device requires electrical connection that provides high tightness, firmness and secureness.

### SUMMARY OF THE INVENTION

The objective of the present invention is provide a photovoltaic electric connector that is easy to connect, and once connected, can provided high level of tightness, firmness and secureness of the connection.

In order to achieve the above objective, the present invention provides a photovoltaic electric connector comprising a first connecting body and a second connecting body. The first connecting body comprising a first connecting seat, a first cable, and a first insulating seat; the second connecting body comprising a second connecting seat, a second cable and a second insulating seat. The first insulating seat surface end is made to form a cylindrical plug head, and the second insulating seat surface end is made to form an extended cylindrical plug socket; the outer wall of the cylindrical plug head forms a first annular groove, and a plural number of arc-shaped elastic pieces are provided inside the first annular groove, where the two ends of the arc-shape elastic pieces are secured in the two ends of the first annular groove;

the outer wall of the cylindrical plug socket forms a second annular groove, where the bottom surface of the second annular groove is made to form a plural number of slots run through the cylindrical plug socket; an annular locking sleeve is provided on the side wall of the second annual groove and the inner wall of the annular locking sleeve is made to form a plural number of L-shape locking bolts; and

the cylindrical plug head of the first insulating seat plugs into the cylindrical plug socket of the second insulating seat, and the elastic pieces on the cylindrical plug head plug and connect with the slots in the cylindrical plug socket and expose through the bottom surface of the second annular groove; the locking bolts of the locking sleeve plug and connect with the elastic pieces that exposes through the outer bottom surface of the second annular groove.

The elastic pieces or slots are uniformly distributed on the cylindrical plug head of the first insulating seat or on the cylindrical plug socket of the second insulating seat; and the number of elastic pieces equals the number of the slots.

The first cable end is made to form a first thread head, the first thread head is plugged and sleeved with a copper tube, the copper tube and the first thread head plug and connect into the first insulating seat; the second cable end is made to form a second thread head, the second thread head is plugged and sleeve with a copper pillar, the copper pillar is inserted and plugged into the copper tube.

The bottom inner wall of the cylindrical plug socket is embedded with a sealing ring, and the cylindrical plug head plugs and connects in the seal ring.

The outer wall of the locking sleeve is made to form a plural number of anti-slipping strips, the anti-slipping strips are uniformly distributed on the locking sleeve, the bottom portion of the locking bolts on the locking sleeve forms an arc shape, and the curvature of arc-shape bottom of the lock bolts is smaller than the curvature between two adjacent slots on the cylindrical plug socket.

The advantages of the present invention are that: the present invention provides a new type of photovoltaic electric connector not only it is easy to connect, it also provides high level of connection tightness, firmness and secureness.

### BRIEF DESCRIPTION OF THE DRAWINGS

FIG. 1 is an illustration of the connection of first connecting body and the second connecting body of the present invention;

FIG. 2 is a sectional view of the connection of first connecting body and the second connecting body;

FIG. 3 is a structural view of the first connecting body;

FIG. 4 is a sectional view of the first connecting body;

FIG. 5 is a structural view of the second connecting body;

FIG. 6 is a sectional view of the second connecting body; and

FIG. 7 is a structural view of the locking sleeve.

### DETAILED DESCRIPTION OF THE PREFERRED EMBODIMENT

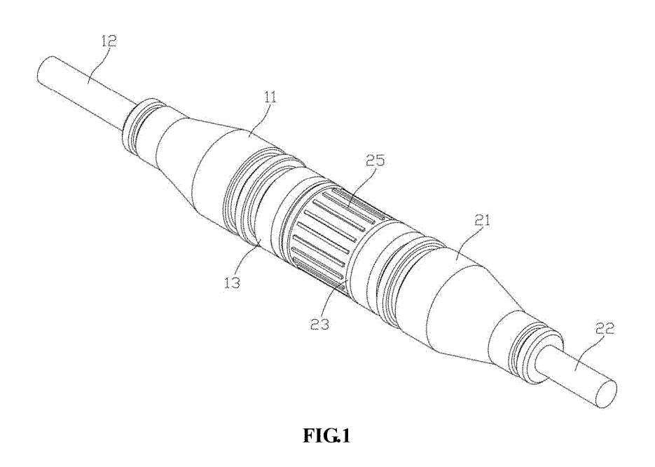

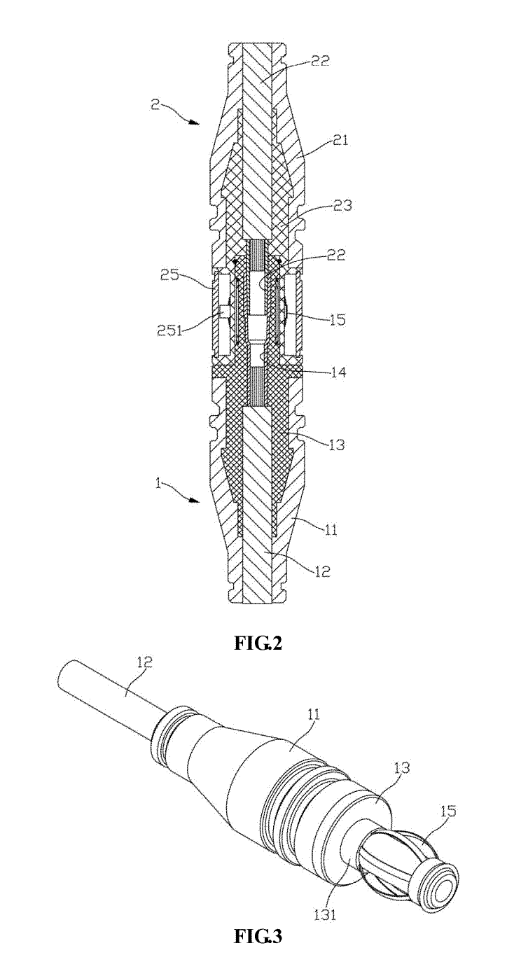

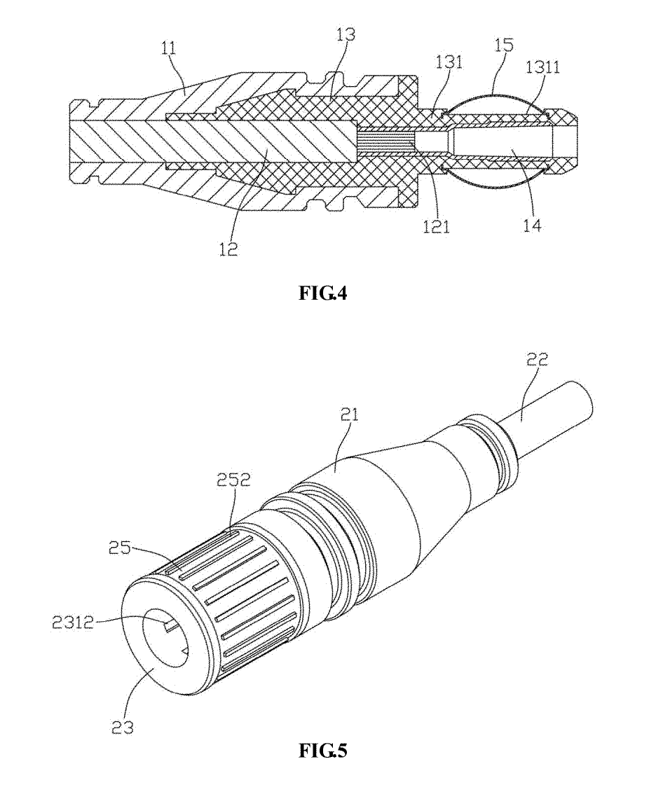

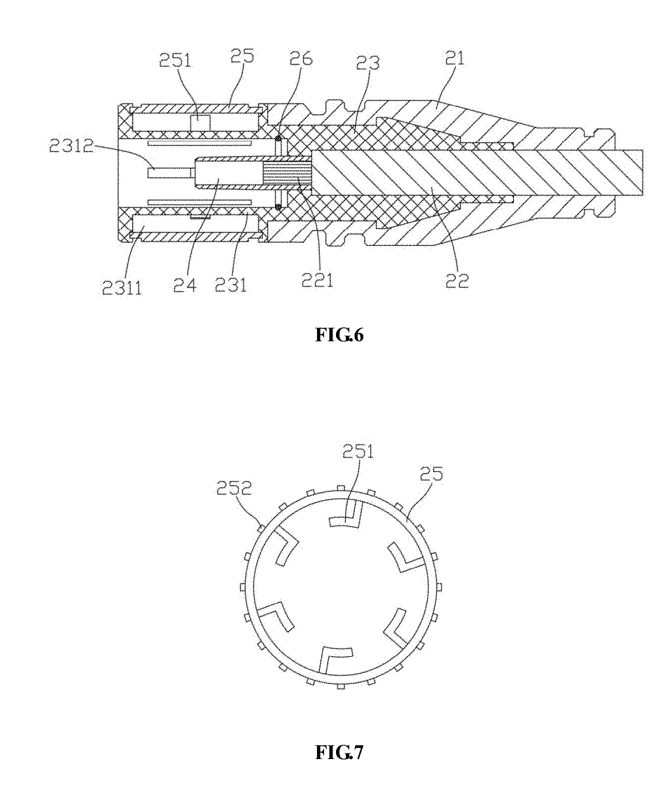

As a preferred embodiment: as shown in FIG. 1˜FIG. 7, a photovoltaic electric connector comprising a first connecting body 1 and a second connecting body 2. The first connecting body 1 comprising a first connecting seat 11, a first cable 12 and a first insulating seat 13. The second connecting body 2 comprising a second connecting seat 21, a second cable 22 and a second insulating seat 23. The surface end of the first insulating seat 13 is made to form a cylindrical plug head 131, the second insulating seat 23 is made to form an extended cylindrical plug socket 231, the outer wall of cylindrical plug head 131 is made to form a first annular groove 1311, a plural number of arc-shape elastic pieces 15 are provided in the first annular groove 1311, and the two ends of the arc-shape elastic pieces 15 are fixed in the two end surface of the first annular groove 1311.

The outer wall of the cylindrical plug socket 231 is made to form a second annular groove 2311. The bottom surface of the second annular groove 2311 is made to form a plural number of slots 2312 that run through cylindrical plug socket 231 and the side wall of the second annular groove 2311 are plugged and connected with an annular locking sleeve 25; the inner wall of the locking sleeve 25 is made to form a plural number of L-shaped locking bolts 251.

The cylindrical plug head 131 on the first insulating seat 13 plugs and connects into the cylindrical plug socket 231 on the second insulating seat 23, the elastic pieces 151 on the cylindrical plug head 131 plug and connect into the slots 2312 on the cylindrical plug socket 231 and expose through the bottom surface of the second annular groove 2311, the lock bolts 251 plug and connect with the elastic piece 15 that expose through the bottom surface of the second annular groove 2311.

The elastic piece 15 or the slots 2312 are uniformly distributed on the cylindrical plug head 131 on the first insulating seat 13 or the cylindrical plug socket 231 on the second insulating seat 23, and the number of the elastic pieces 15 equals the number of the slots 2312.

The end of the first cable 12 is made to form a first thread head 121, the first thread head 121 is plugged and sleeved with a copper tube 14, and the copper tube 14 and the first thread heat 121 plug and connect into the first insulating seat 13; the end of the second cable 22 is made to form a second thread head 221, the second thread head 221 is plugged and sleeved with a copper pillar 24, and the copper pillar 24 plug and connect into the copper tube 14.

The bottom inner wall of the cylindrical plug socket 231 is embedded with a sealing ring 26, and the cylindrical plug head 131 plugs and connects into the seal ring.

The outer wall of the locking sleeve 25 is made to form a plural number of anti-slipping strips 252, the anti-slipping strips 252 are uniformly distributed on the locking sleeve 25, the bottom portion of the locking bolts 251 on the locking sleeve 25 forms an arc shape, and the curvature of arc-shape bottom of the lock bolts 251 is smaller than the curvature between two adjacent slots 2312 on the cylindrical plug socket 231.

Working principle: the present invention photovoltaic electrical connector comprising an assembly of a first connecting body 1 and a second connecting body 2, when operating, plug in the cylindrical plug head 131 of the first connecting body 1 into the cylindrical plug socket 231 of the second connecting body 2, at the same time, the elastic pieces 15 on the cylindrical plug head 131 are pressed and deformed against the inner wall of the cylindrical plug socket 231 and slide into the cylindrical plug head 131, then the elastic pieces 15 slide into the slots 2312 of the cylindrical plug socket 231 and finally the elastic pieces 15 return to their original shape to complete the connection of the first connecting body 1 and the second connecting body 2. The simply connection operation made the connecting process easy, and at the same time, where the copper pillar 24 plugs and connects into the copper tube 14, making the connection tighter. In addition, the cylindrical plug head 131 plugs and connects into the sealing 26 of the cylindrical plug socket 231, for better sealing effect. To disconnect the electrical connector, simply pull and unplug the first connecting body 1 from the second connecting body 2.

In order to strengthen the connection of the first connecting body 1 and the second connecting body 2, the lock bolts 251 of the locking sleeve 25 plug and connect into the elastic pieces 15 for preventing the first connecting body 1 separating from the second connecting body 2.

Although the invention has been explained in relation to its preferred embodiment, it is to be understood that many other possible modifications and variations can be made without departing from the spirit and scope of the invention as hereinafter claimed.

1. A photovoltaic electrical connector comprising a first connecting body and a second connecting body; the first connecting body comprising a first connecting seat, a first cable and a first insulating seat; the second connecting body comprising a second connecting seat, a second cable and a second insulating seat; the end surface of the first insulating seat is made to form a cylindrical plug head, and the end surface of the second insulating seat is made to form a cylindrical plug socket; it is characterized that: the outer wall of the cylindrical plug head is made to form a first annular groove, wherein, a plural number of arc-shape elastic pieces are provided in the first annular groove; the two end of the elastic pieces are fixed in the two inner end sides of the first annular groove; the outer wall of the cylindrical plug socket is made to form a second annular groove; wherein the bottom surface of the second annular groove is made to form a plural number of slots that run through the cylindrical plug socket; the side wall of the second annular groove are plugged and connected with an annular locking sleeve; wherein the inner wall of the locking sleeve is made to form a plural number of L-shape locking bolts; the cylindrical plug head of the first insulating seat plugs and connects into the cylindrical plug socket of the second insulating seat; wherein the elastic pieces on the cylindrical plug head plug and connect into the slots on the cylindrical plug socket and expose through the bottom surface of the second annular groove; and the locking bolts of the locking sleeve plug and connect into the elastic pieces that expose through the bottom surface of the second annular groove.

2. The photovoltaic electrical connector as claimed in claim 1, it is characterized that: said elastic pieces or slots are uniformly distributed on the cylindrical plug head of the first insulating seat or the cylindrical plug socket of the second insulating seat; wherein the number of elastic pieces equals the number of the slots.

3. The photovoltaic electrical connector as claimed in claim 1, it is characterized that: one end of the first cable is made to form a first thread head and the first thread head is plugged and sleeved with a copper tube; said copper tube the first thread head plug and connect into the first insulating seat; one end of the second cable is made to form a second thread head and the second thread head is plugged and sleeved with a copper pillar; said copper pillar plugs and connects into the copper tube.

4. The photovoltaic electrical connector as claimed in claim 1, it is characterized that: the bottom inner wall of the cylindrical plug socket is provided with a sealing ring, wherein the cylindrical plug head plugs and connects into the said sealing ring.

5. The photovoltaic electrical connector as claimed in claim 1, it is characterized that: the outer wall of the locking sleeve is made to form a plural number of anti-slip strips, said anti-slip strips are uniformly distributed on the locking sleeve; the bottom section of the locking bolts on the locking sleeve forms an arc shape, and the curvature of arc-shape bottom of the lock bolts is smaller than the curvature between two adjacent slots on the cylindrical plug socket.
